(19) United States
(12) Patent Application Publication
(10) Pub. No.: US 2016/0071048 A1
(43) Pub. Date: Mar. 10, 2016

(54) METHODS AND SYSTEMS FOR CROWDSOURCING OF TASKS

(71) Applicant: Xerox Corporation, Norwalk, CT (US)

(72) Inventors: Sujit Gujar, Pune (IN); Chithralekha Balamurugan, Pondicherry (IN); Chandrashekhar Lakshminarayanan, Tamil Nadu (IN); Srujana Sadula, Andhra Pradesh (IN); Shalabh Bhatnagar, Bangalore (IN)

(21) Appl. No.: 14/479,390

(22) Filed: Sep. 8, 2014

(51) Int. Cl. G06Q 10/06

(52) U.S. Cl. CPC G06Q 10/063112

(57) ABSTRACT

The disclosed embodiments illustrate methods and systems for formulating a policy for crowdsourcing of tasks. The method includes receiving a set of incoming tasks and a range associated with a task attribute corresponding to each task in the set of incoming tasks. Thereafter, an execution of a first policy is simulated over a period of time to determine one or more first performance metrics, associated with the execution of the first policy. The first policy is based on a first value selected from the range. Further, the first value is updated to generate a second value based on the one or more first performance metrics, wherein the second value is deterministic of the policy for crowdsourcing of the set of incoming tasks over the period of time.

### TECHNICAL FIELD

The presently disclosed embodiments are related, in general, to crowdsourcing. More particularly, the presently disclosed embodiments are related to methods and systems for formulating a policy for crowdsourcing tasks.

### BACKGROUND

With the emergence of enterprise crowdsourcing, many large corporate houses/enterprises are outsourcing a significant amount of work as tasks to loosely bound groups of workers over the internet through one or more crowdsourcing platforms. Examples of such tasks include, but are not limited to, image tagging, form digitization, and so on. The corporate houses/enterprises may need a time-bounded and a high quality solution for the crowdsourced tasks to meet internal/external Service Level Agreements (SLAs) associated with the crowdsourced tasks. Therefore, the corporate houses/enterprises may need to design the tasks carefully and set remuneration and other polices associated with the tasks in a manner that the SLAs associated with the crowdsourced tasks are met.

### SUMMARY

According to embodiments illustrated herein, there is provided a method for formulating a policy for crowdsourcing tasks. The method comprises receiving a set of incoming tasks and a range associated with a task attribute corresponding to each task in the set of incoming tasks. Thereafter, an execution of a first policy over a period of time is simulated to determine one or more first performance metrics, associated with the execution of the first policy. The first policy is based on a first value selected from the range. Further, the first value is updated to generate a second value based on the one or more first performance metrics, wherein the second value is deterministic of the policy for crowdsourcing of the set of incoming tasks over the period of time.

According to embodiments illustrated herein, there is provided a method for formulating a pricing policy for crowdsourcing tasks. The method comprises receiving a set of incoming tasks and a range of a cost incurable by a requestor on each task in the set of incoming tasks. Thereafter, an execution of a first policy over a period of time is simulated to determine a first completion time, associated with the execution of the first policy. The first policy is based on a first value of the cost selected from the range. The first completion time corresponds to a time consumable by one or more crowdworkers for completing the set of incoming tasks when crowdsourced at the first policy. Further, the simulation of the execution of the first policy comprises simulating a behavior of the one or more crowdworkers. Thereafter, the first value is updated to generate a second value of the cost based on the first completion time, wherein the second value is deterministic of the pricing policy for crowdsourcing of the set of incoming tasks over the period of time.

According to embodiments illustrated herein, there is provided a system for formulating a policy for crowdsourcing tasks. The system includes one or more processors that are operable to receive a set of incoming tasks and a range associated with a task attribute corresponding to each task in the set of incoming tasks. Thereafter, an execution of a first policy over a period of time is simulated to determine one or more first performance metrics, associated with the execution of the first policy. The first policy is based on a first value selected from the range. Further, the first value is updated to generate a second value based on the one or more first performance metrics, wherein the second value is deterministic of the policy for crowdsourcing of the set of incoming tasks over the period of time.

According to embodiments illustrated herein, there is provided a computer program product for use with a computing device. The computer program product comprises a non-transitory computer readable medium, the non-transitory computer readable medium stores a computer program code for formulating a policy for crowdsourcing tasks. The computer readable program code is executable by one or more processors in the computing device to receive a set of incoming tasks and a range associated with a task attribute corresponding to each task in the set of incoming tasks. Thereafter, an execution of a first policy over a period of time is simulated to determine one or more first performance metrics, associated with the execution of the first policy. The first policy is based on a first value selected from the range. Further, the first value is updated to generate a second value based on the one or more first performance metrics, wherein the second value is deterministic of the policy for crowdsourcing of the set of incoming tasks over the period of time.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment, in which various embodiments can be implemented;

FIG. 2 is a block diagram that illustrates a system for formulating a policy (e.g., a pricing policy) for crowdsourcing of a set of incoming tasks, in accordance with at least one embodiment;

FIG. 3 is a flowchart that illustrates a method for formulating a policy for crowdsourcing of a set of incoming tasks, in accordance with at least one embodiment;

FIG. 4 is a flowchart that illustrates a method for formulating a pricing policy for crowdsourcing of a set of incoming tasks, in accordance with at least one embodiment; and

FIG. 5 is a block diagram that illustrates an example of a policy simulator used for formulating a policy for crowdsourcing of a set of incoming tasks, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example”, and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

### DEFINITIONS

The following terms shall have, for the purposes of this application, the meanings set forth below.

A “task” refers to a piece of work, an activity, an action, a job, an instruction, or an assignment to be performed. Tasks may necessitate the involvement of one or more workers. Examples of tasks include, but are not limited to, digitizing a document, generating a report, evaluating a document, conducting a survey, writing a code, extracting data, translating text, and the like.

“Crowdsourcing” refers to distributing tasks by soliciting the participation of loosely defined groups of individual crowdworkers. A group of crowdworkers may include, for example, individuals responding to a solicitation posted on a certain website such as, but not limited to, Amazon Mechanical Turk, Crowd Flower, or Mobile Works.

A “crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms include, but are not limited to, Amazon Mechanical Turk, Crowd Flower, or Mobile Works.

A “crowdworker” refers to a workforce/worker(s) that may perform one or more tasks that generate data that contributes to a defined result. According to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker”, “crowdsourced workforce”, and “crowd” may be used interchangeably.

A “remuneration” refers to an amount paid to a worker for completing a task posted on a crowdsourcing platform. In an embodiment, examples of the remuneration may include, but are not limited to, a monetary compensation, lottery tickets, gift items, shopping vouchers, and discount coupons. In another embodiment, remuneration may further correspond to strengthening of the relationship between the worker and the requestor. For example, the requestor may provide the worker with an access to more tasks so that the worker can gain more. In addition, the crowdsourcing platform may improve a reputation score associated with the worker. In an embodiment, the worker with a higher reputation score may receive a higher remuneration. A person skilled in the art would understand that combination of any of the above-mentioned means of remuneration could be used and the task completion cost for the requestors may be inclusive of such remunerations receivable by the corresponding workers.

A “task cost/price” refers to a cost/expense incurred by a requestor to get the tasks completed through crowdsourcing. In an embodiment, the task cost may include a remuneration payable by the requestors to the workers for working on the tasks. The task cost/price may further include an amount payable by the requestor to the crowdsourcing platform for hosting the task submitted by the requestor, to get the task completed by one or more workers.

“One or more performance metrics” correspond to at least a performance measure of processing of one or more tasks on the crowdsourcing platform. In an embodiment, the one or more performance metrics comprises at least one of a task completion time, a task accuracy, a task completion rate, or a number of tasks completed in a period.

“Historical data” refers to statistical data associated with the processing of the one or more tasks by one or more workers over a period of time. In an embodiment, the historical data may include a measure of one or more performance metrics associated with the performance of the one or more tasks, e.g., a task accuracy, a task quality, a time completion time, etc. In an embodiment, the historical data may be collected from the one or more crowdsourcing platforms at regular intervals of time. Further, the historical data may include information pertaining to time at which the one or more crowdworkers are active and ready to accept tasks.

A “task accuracy” refers to a ratio of a number of correct responses to a total number of responses provided by a crowdworker for one or more tasks attempted by the crowdworker. For example, if a worker attempts 10 tasks and provides correct responses for 7 tasks, the task accuracy of the worker is 0.7 (i.e., 7/10). In an embodiment, the task accuracy may correspond to an average accuracy score attained by one or more workers who attempt a particular task. For example, four workers attempt a task and attain accuracy scores of 0.5, 0.6, 0.7, and 0.8. In this scenario, the task accuracy for the particular task is the average of the accuracy scores of the individual workers, i.e., 0.65 (i.e., (0.5+0.6+0.7+0.8)/4). Thus, a person skilled in the art would appreciate the term “task accuracy” may refer to the accuracy score attained by a worker who attempts multiple tasks and alternatively the task accuracy may be task specific and correspond to the average of task accuracy scores attained by multiple workers who attempt a particular task.

A “task quality” refers to a qualitative assessment of the responses received from the worker for the one or more tasks. In an embodiment, the qualitative assessment may be made based on one or more heuristics using factors such as, a time taken by the worker to complete the task, an average task accuracy of the worker on the one or more tasks, and so on.

A “task completion time” refers to a time consumed by a worker to complete a task.

“One or more task attributes” refer to a set of configurable or inherent features associated with the one or more tasks submitted or being submitted on the crowdsourcing platform by one or more requestors. In an embodiment, the one or more task attributes may be classified as task design attributes and task policy attributes. In an embodiment, task design attributes may define or control a design or workflow of the tasks being submitted to a crowdsourcing platform. Examples of the task design attributes include, but are not limited to, a posting time of the tasks, an expiry time of the tasks, a number of instances of each task, a task type associated with each task, or a unit price associated with each task. In an embodiment, the requestors may specify the task design attributes associated with the tasks. Alternatively, the task design attributes may be determined heuristically from the task based on historical data associated with the crowdsourcing of tasks on the crowdsourcing platform. In an embodiment, the task policy attributes are a set of configurable attributes associated with the tasks that govern a policy associated with the crowdsourcing of the tasks on a crowdsourcing platform. In an embodiment, the task policy attributes may be configurable by the one or more requestors. Examples of the task policy attributes include, but are not limited to, a price associated with each task, one or more crowdsourcing platforms for crowdsourcing of the tasks, a task schedule associated with crowdsourcing of the tasks, a re-posting of the task on a crowdsourcing platform (i.e., how/when the tasks are re-submitted to the crowdsourcing platform after the elapse of expiry time of the tasks), or a task switching between the one or more crowdsourcing platforms.

“Unit price” refers to a base price associated with a crowdsourcing task offered to one or more crowdworkers through a crowdsourcing platform. In an embodiment, the unit price may correspond to a minimum price (i.e., minimum remuneration receivable by a worker) at which the task can be posted on the crowdsourcing platform. In an embodiment, unit price is a task design attribute associated each task posted on the crowdsourcing platform. In an embodiment, the unit price associated with a task posted by a requestor on a crowdsourcing platform may include fees, which is paid to the crowdsourcing platform by the requestor for hosting the task, in addition to a remuneration, which is paid to one or more crowdworkers for completing/attempting the task.

“Task price” refers to a negotiable price, greater than or equal to the unit price, at which a crowdsourcing task may be offered to one or more crowdworkers through a crowdsourcing platform. In an embodiment, the task price equals unit price times a budget factor, wherein the budget factor corresponds to a cost budgeted by a requestor for crowdsourcing the task through the crowdsourcing platform. Thus, the task price associated with a task is an inflated version of the base price for the task (i.e., the unit price), which depends on the budget factor. In an embodiment, task price is a task policy attribute associated with each task posted on the crowdsourcing platform.

“A posting time” refers to a time at which a task is submitted by a requestor to the crowdsourcing platform.

“An expiry time” refers to a time at which a task submitted by a requestor to the crowdsourcing platform becomes invalid. In an embodiment, the task may be pulled back from the crowdsourcing platform at the expiry time. However, the requestor may re-post (re-submit) the same task on the same or another crowdsourcing platform, if the need be.

“A task instance” refers to a replica/copy of a task that can be picked-up by a worker for completion. In an embodiment, each task may have multiple task instances, each of which may be attempted by an individual crowdworker. The multiple instances of the same task may help in obtaining a consensus of responses for the task. For example, a crowdsourcing platform such as Amazon Mechanical Turk refers a task instance as a Human Intelligence Task (HIT).

“Incoming tasks” refer to a traffic/stream of tasks that are received from one or more individuals or enterprise requestors. For example, if an enterprise requestor uploads 150 tasks on a crowdsourcing platform on an average in one hour, then 150 tasks/hour is the measure of task traffic generated by such an enterprise requestor.

“Parameter” refers to a tunable characteristic that controls the task policy attributes, associated with one or more tasks. The parameter is used to determine/formulate a policy for crowdsourcing one or more tasks of the requestor. Hence, in an embodiment, the parameter may define a formulation of a policy for crowdsourcing tasks received from the requestor.

“Policy” refers to strategy/plan utilized for making business decisions with a view to optimize returns associated with the business context. For example, in crowdsourcing domain, a policy may be formulated to define a predetermined task schedule for crowdsourcing of the tasks on a crowdsourcing platform to minimize task completion time. In an embodiment, a policy associated with crowdsourcing of a set of incoming tasks (for a given time period) may be determined based on a value of a task attribute selected from a range by utilizing an optimization algorithm.

“Period” refers to time interval (T) for which a policy is formulated. For example, a policy for crowdsourcing tasks for a period of time (T), where T equals one month.

“Pricing policy” refers to a policy that governs the pricing of tasks being crowdsourced on a crowdsourcing platform. In an embodiment, the pricing policy may determine a remuneration receivable by one or more workers for attempting the one or more tasks posted on the crowdsourcing platform. In an embodiment, the value of the task policy attribute, “task price”, may govern the pricing policy for the tasks.

“Policy vector” refers to a parameterized vector that controls a task policy attribute. In an embodiment, with reference to the task policy attribute under consideration, the policy vector is utilizable for optimizing one or more performance metrics associated with the crowdsourcing of the set of incoming tasks over a period of time (T).

“Perturbation” refers to a deviation/variation performed on a variable under consideration. In an embodiment, the value of the perturbation may be very small as compared to the value of the variable under consideration. In an embodiment, the variable under consideration may be perturbed to perform a gradient update on the variable under consideration. Example, value of a variable under consideration, say X is 1, and the perturbation of this variable (X_{Perturbation}) is 0.00001. Thus, (X_{Perturbation}/X)→0.

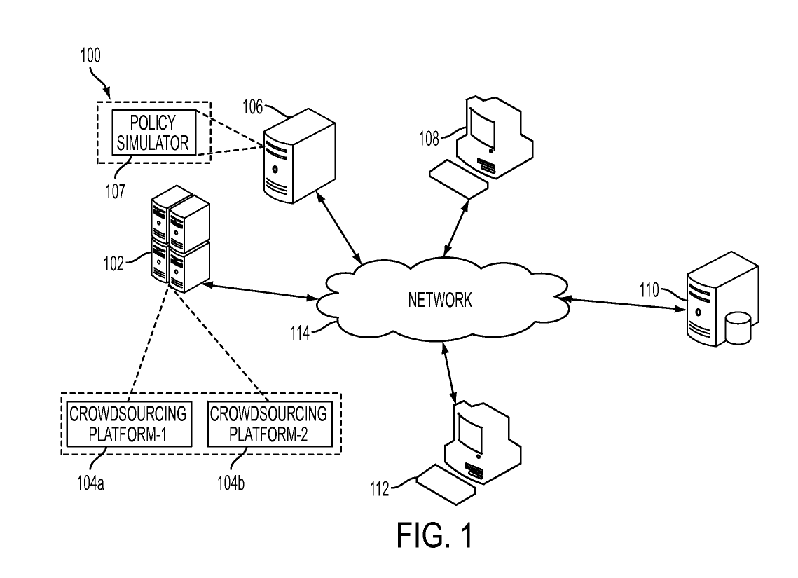

FIG. 1 is a block diagram of a system environment 100, in which various embodiments can be implemented. The system environment 100 includes a crowdsourcing platform server 102, an application server 106, a requestor-computing device 108, a database server 110, a worker-computing device 112, and a network 114.

In an embodiment, the crowdsourcing platform server 102 is configured to host one or more crowdsourcing platforms (for e.g., a crowdsourcing platform-1 104a and a crowdsourcing platform-2 104b). In an embodiment, the crowdsourcing platform (e.g., 104a) may receive one or more tasks from one or more requestors. In an embodiment, the crowdsourcing platform (e.g., 104a) may group the one or more tasks into one or more task groups based on one or more attributes associated with each of the one or more tasks. For example, the crowdsourcing platform server 102 may group the one or more tasks based on the type of the task. In an embodiment, the task type associated with a task corresponds to a type of workflow associated with the task. Thus, in an embodiment, the workflow may correspond to one or more steps that the worker may be required to perform to attempt the task. Various examples of task types include, but are not limited to, image/video/text labeling/tagging/categorization, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography (e.g., of product placement), text/image analysis, directory compilation, or information search/retrieval. In an example scenario, the crowdsourcing platform (e.g., 104a) may group the one or more tasks into a first task group containing form digitization tasks and a second task group containing image-tagging tasks. In the foregoing example, the one or more tasks are grouped based on the task type. However, a person skilled in the art would appreciate that the one or more tasks may be grouped based on any other task attribute without departing from the scope of the disclosure.

In an embodiment, each task may include one or more task instances, which may be offered to one or more workers registered with the crowdsourcing platform (e.g., 104a). In an embodiment, each of the one or more task instances may correspond to a copy/replica of the task that may be assigned to an individual worker. In an embodiment, the crowdsourcing platform (e.g., 104a) presents a user interface to the one or more workers through a web-based interface or a client application. The one or more workers may access the one or more tasks (each of which include the one or more task instances) through the web-based interface or the client application. Further, the one or more workers may pick a task (i.e., a task instance of the selected task) from a task group and perform the particular task. Thereafter, the one or more workers may submit a response for the task to the crowdsourcing platform (e.g., 104a) through the user interface. In an embodiment, the crowdsourcing platform (e.g., 104a) may forward the responses received for the tasks in each task group to the one or more requestors.

Further, in an embodiment, the crowdsourcing platform server 102 may monitor the crowdsourcing platform (e.g., 104a) to collect statistical data pertaining to a performance data associated with the one or more workers performing the one or more tasks. In an embodiment, the performance data may include a measure of one or more performance metrics associated with the performance of the one or more tasks. In another embodiment, the crowdsourcing platform (e.g., 104a) may collect the statistical data and determine the one or more performance metrics. In such a scenario, the crowdsourcing platform (i.e., 104a) may periodically provide the crowdsourcing platform server 102 with such information, i.e., the statistical data and the one or more performance metrics. In an embodiment, the crowdsourcing platform server 102 (or the crowdsourcing platform, e.g., 104a) may maintain the statistical data and the one or more performance metrics as a historical data, which may be updated at regular intervals of time. In an embodiment, the historical data may be stored in the database server 110.

A person having ordinary skill in the art would understand that though FIG. 1 illustrates the crowdsourcing platform server 102 as hosting only two crowdsourcing platforms (i.e., the crowdsourcing platform-1 104a and the crowdsourcing platform-2 104b), the crowdsourcing platform server 102 may host more than two crowdsourcing platforms without departing from the spirit of the disclosure.

In an embodiment, the crowdsourcing platform server 102 may be realized through an application server such as, but not limited to, a Java application server, a .NET framework, and a Base4 application server.

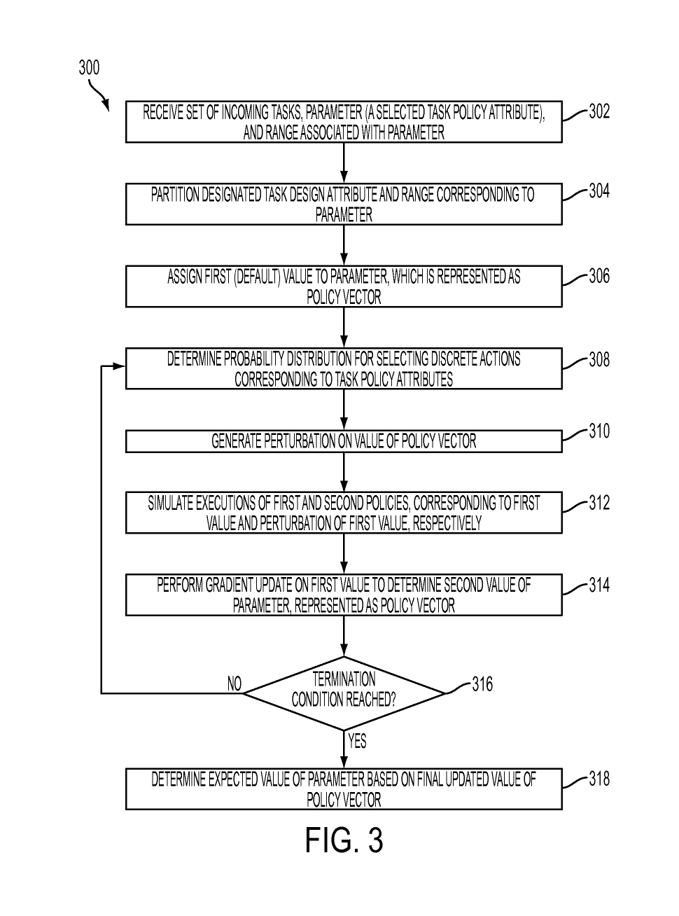

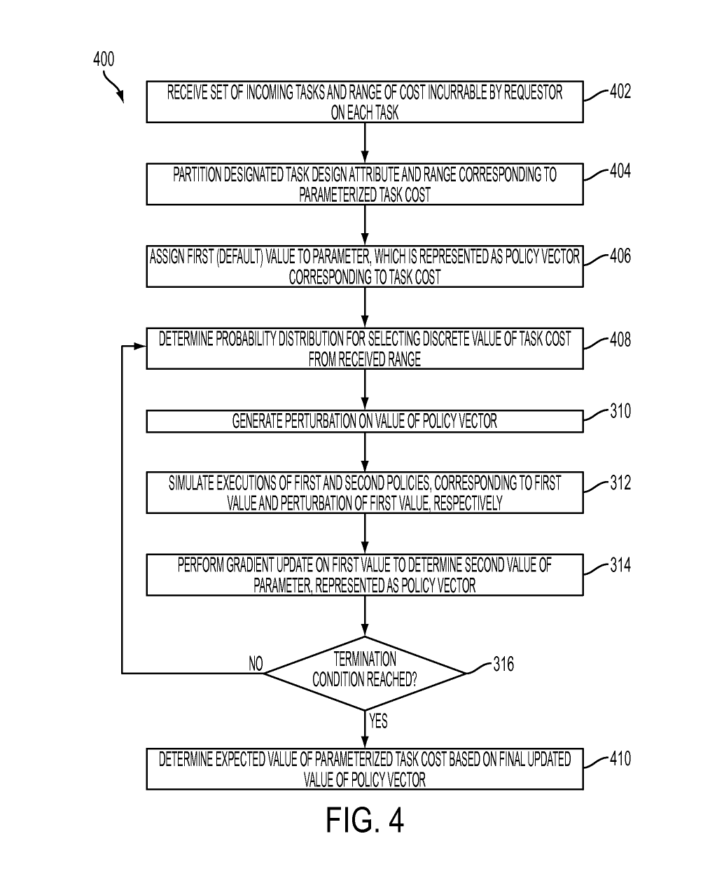

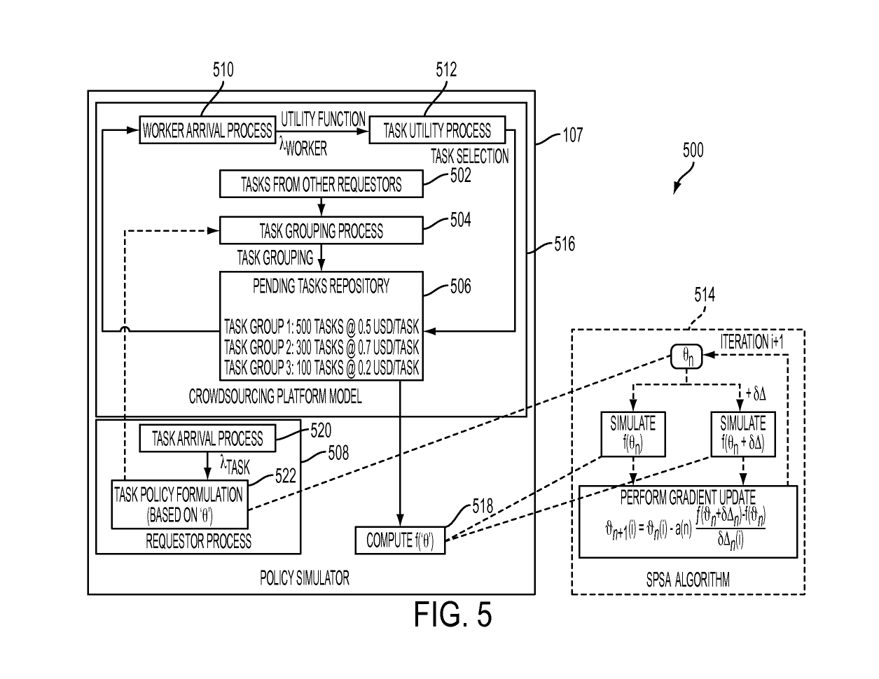

In an embodiment, the application server 106 is configured to receive a traffic of tasks (a set of incoming tasks received over a period of time, say T days) from a requestor. In addition, in an embodiment, the application server 106 may further receive a parameter associated with formulating a policy for crowdsourcing the set of incoming tasks over the period of time, i.e., T days. In an embodiment, the requestor may provide one or more task attributes associated with the set of incoming tasks. The one or more task attributes may include task design attributes, that are inherent to the set of incoming tasks, and task policy attributes, that are utilizable for formulating a policy for crowdsourcing of the set of incoming tasks. In an embodiment, the parameter may correspond to a task policy attribute from the one or more task policy attributes selected by the requestor for the policy formulation. The requestor may further provide a range for the parameter. In an embodiment, the application server 106 may utilize a policy simulator 107 for simulating one or more policies associated with crowdsourcing of the set of incoming tasks, based on the parameter and the range. The formulation of a policy for crowdsourcing of the set of incoming tasks has been explained further in conjunction with FIG. 3. The formulation of a pricing policy for crowdsourcing of the set of incoming tasks has been explained in conjunction with FIG. 4. The policy simulator 107 has been explained further in conjunction with FIG. 5.

Some examples of the application server 106 may include, but are not limited to, a Java application server, a .NET framework, and a Base4 application server.

A person with ordinary skill in the art would understand that the scope of the disclosure is not limited to illustrating the application server 106 as a separate entity. In an embodiment, the functionality of the application server 106 may be implementable on/integrated with the crowdsourcing platform server 102.

In an embodiment, the requestor-computing device 108 is a computing device used by the requestor to upload the one or more tasks (e.g., the set of incoming tasks) to the crowdsourcing platform (e.g., 104a). In an embodiment, the requestor may upload the one or more tasks (e.g., the set of incoming tasks) to the application server 106. The application server 106 may utilize the policy simulator 107 to recommend a policy (e.g., a pricing policy) to the requestor for crowdsourcing the one or more tasks. Thereafter, the application server 106 may forward the one or more tasks (e.g., the set of incoming tasks) to the crowdsourcing platform (e.g., 104a). Alternatively, the requestor may directly send the one or more tasks (e.g., the set of incoming tasks) to the crowdsourcing platform (e.g., 104a). Examples of the requestor-computing device 108 include, but are not limited to, a personal computer, a laptop, a personal digital assistant (PDA), a mobile device, a tablet, or any other computing device.

In an embodiment, the database server 110 is configured to store the historical data associated with the crowdsourcing platform 104a. In an embodiment, the database server 110 may receive a query from the crowdsourcing platform server 102 and/or the application server 106 to extract/update the historical data. The database server 110 may be realized through various technologies such as, but not limited to, Microsoft® SQL server, Oracle, and My SQL. In an embodiment, the crowdsourcing platform server 102 and/or the application server 106 may connect to the database server 110 using one or more protocols such as, but not limited to, Open Database Connectivity (ODBC) protocol and Java Database Connectivity (JDBC) protocol.

A person with ordinary skill in the art would understand that the scope of the disclosure is not limited to the database server 110 as a separate entity. In an embodiment, the functionalities of the database server 110 can be integrated into the crowdsourcing platform server 102 and/or the application server 106.

In an embodiment, the worker-computing device 112 is a computing device used by the worker. The worker-computing device 112 is configured to present the user interface (received from the crowdsourcing platform) to the worker. The worker is presented with the one or more tasks received from the crowdsourcing platform (e.g., 104a) through the user interface. Thereafter, the worker may submit the responses for the one or more tasks through the user interface to the crowdsourcing platform (e.g., 104a). Examples of the worker-computing device 112 include, but are not limited to, a personal computer, a laptop, a personal digital assistant (PDA), a mobile device, a tablet, or any other computing device.

The network 114 corresponds to a medium through which content and messages flow between various devices of the system environment 100 (e.g., the crowdsourcing platform server 102, the application server 106, the requestor-computing device 108, the database server 110, and the worker-computing device 112). Examples of the network 114 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 114 in accordance with various wired and wireless communication protocols such as Transmission Control Protocol and Internet Protocol (TCP/IP), User Datagram Protocol (UDP), and 2G, 3G, or 4G communication protocols.

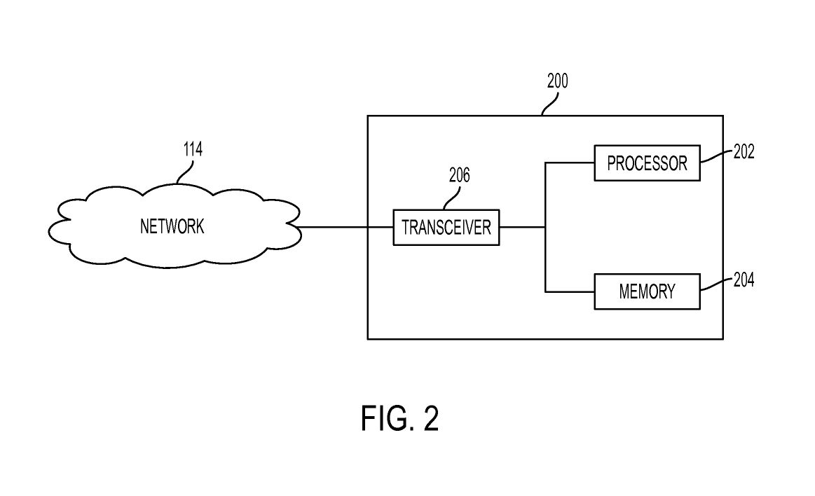

FIG. 2 is a block diagram that illustrates a system 200 for formulating a policy (e.g., a pricing policy) for crowdsourcing of the set of incoming tasks, in accordance with at least one embodiment. In an embodiment, the system 200 may correspond to the crowdsourcing platform server 102, the application server 106, or the requestor-computing device 108. For the purpose of ongoing description, the system 200 is considered as the application server 106. However, the scope of the disclosure should not be limited to the system 200 as the application server 106. The system 200 can also be realized as the crowdsourcing platform server 102 or the requestor-computing device 108.

The system 200 includes a processor 202, a memory 204, and a transceiver 206. The processor 202 is coupled to the memory 204 and the transceiver 206. The transceiver 206 is connected to the network 114.

The processor 202 includes suitable logic, circuitry, and/or interfaces that are operable to execute one or more instructions stored in the memory 204 to perform predetermined operations. The processor 202 may be implemented using one or more processor technologies known in the art. Examples of the processor 202 include, but are not limited to, an x86 processor, an ARM processor, a Reduced Instruction Set Computing (RISC) processor, an Application-Specific Integrated Circuit (ASIC) processor, a Complex Instruction Set Computing (CISC) processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person with ordinary skills in the art that the one or more instructions stored in the memory 204 enable the hardware of the system 200 to perform the predetermined operations. In an embodiment, the one or more instructions stored on the memory 204 may correspond to the policy simulator 107.

The transceiver 206 transmits and receives messages and data to/from various components of the system environment 100 (e.g., the crowdsourcing platform server 102, the requestor-computing device 108, the database server 110, and the worker-computing device 112) over the network 114. Examples of the transceiver 206 may include, but are not limited to, an antenna, an Ethernet port, a USB port, or any other port that can be configured to receive and transmit data. The transceiver 206 transmits and receives data/messages in accordance with the various communication protocols, such as, TCP/IP, UDP, and 2G, 3G, or 4G communication protocols.

An embodiment of the operation of the system 200 for formulating a policy for crowdsourcing of the set of incoming tasks has been described in conjunction with FIG. 3.

FIG. 3 is a flowchart 300 that illustrates a method for formulating a policy for crowdsourcing of the set of incoming tasks, in accordance with at least one embodiment. The flowchart 300 is described in conjunction with FIG. 1 and FIG. 2.

At step 302, the set of incoming tasks are received. In an embodiment, the processor 202 is configured to receive the set of incoming tasks (i.e., the traffic of tasks) from the requestor-computing device 108. In an embodiment, along with the set of incoming tasks, the requestor may provide one or more task attributes associated with each of the set of incoming tasks. In an embodiment, the one or more tasks attributes may include task design attributes and task policy attributes. The requestor may select a task policy attribute as a parameter to be considered for policy formulation. Further, the requestor may provide a range for the parameter to be optimized for formulation of the policy. In an embodiment, the value of the parameter may determine the value of the task policy attribute chosen for optimization. Example, the requestor chooses the task policy attribute “task price” and provides a range for the parameter (i.e., Budget Factor) to be between 1.0 and 2.0. Thus, any value for the task price, i.e., the task policy attribute being optimized through the parameter, may be chosen based on this range. In an embodiment, the value of the parameter so chosen may be deterministic of the policy for crowdsourcing the set of incoming tasks. Further, in an embodiment, the requestor may designate a task design attribute from the one or more task design attributes for the formulation of the policy. Thus, this designated task design attribute, along with the selected task policy attribute (through the parameter), may be utilized for formulating the policy for crowdsourcing of the set of incoming tasks.

A person skilled in the art would appreciate that the scope of the disclosure is not limited to the designated task design attribute and the selected task policy attribute as a single designated task design attribute and a single selected task policy attribute respectively. The disclosure may be implemented with multiple designated task design attributes and multiple selected task policy attributes without departing from the scope of the disclosure.

In an embodiment, the set of incoming tasks may correspond to a task group. In another embodiment, the set of incoming tasks may include tasks that correspond to more than one task groups. In an embodiment, the grouping of the set of incoming tasks into the one or more task groups may be performed by the application server 106 based on the one or more task design attributes associated each task in the set of incoming tasks. For example, the application server 106 may group the tasks into the one or more tasks groups based on the one or more task design attributes such as task type, unit price, and so on. In an alternate embodiment, the crowdsourcing platform (e.g., 104a) may group the set of incoming tasks into the one or more task groups, when the set of incoming tasks are received by the crowdsourcing platform (e.g., 104a).

### Task Design Attributes

In an embodiment, the task design attributes may determine the design of the tasks. Further, the task design attributes may correspond to one or more inherent properties of the tasks, e.g., posting time of tasks, a task type associated with each task, and so on. Other examples of the one or more task design attributes may include, but are not limited to, an expiry time of the set of incoming tasks, a number of task instances in the set of incoming tasks, and a unit price associated with each task. The following table illustrates example values of the one or more task design attributes:

TABLE 1
Example of task design attributes associated with each task

| Task design attribute | Value |
|---|---|
| Posting time | Day 1, 9 AM |
| Expiry time | Day 4, 7 PM |
| Number of instances of tasks | 1000 |
| Task type | Form digitization |
| Unit price per task | 0.2 USD (20 cents)/task |

As evident from the above table, the number of instances of tasks in set of incoming tasks is 1000. Further, the posting time of the set of incoming tasks is on Day 1 (say a Monday) at 9 AM, while the expiry time of the set of incoming tasks is Day 4 (say, the succeeding Thursday) at 7 PM. The task type associated with each task is “form digitization” and the unit price per task is 20 cents/task. Thus, the remuneration receivable by a worker for performing an instance if the task is 20 cents.

In an embodiment, the requestor may provide values of the one or more task design attributes. Alternatively, the application server 106 may determine the values of the task design attributes. For example, posting time of the set of incoming tasks may be determined based on the time at which the set of incoming tasks are received from the requestor. Further, the unit price per task may be determined as the minimum price (or base price) associated with the crowdsourcing of tasks on the crowdsourcing platform (e.g., 104a). Alternatively, the historical data associated with the requestor may be utilized to determine the unit price per task.

A person skilled in the art would appreciate that the examples provided above for the determination of the task design attributes are for illustrative purposes only. The scope of the disclosure should not be limited to such examples.

### Task Policy Attributes

In an embodiment, the task policy attributes may be utilized to determine a policy associated with the crowdsourcing of the set of incoming tasks on the one or more crowdsourcing platforms (e.g., 104a and 104b). Examples of the one or more task policy attributes may include, but are not limited to, a price associated with each task (also referred as task price), one or more crowdsourcing platforms for crowdsourcing of the tasks, a number of task instances within the set of incoming task, a task schedule associated with crowdsourcing of the tasks, a re-posting of the task on a crowdsourcing platform, and a task switching between the one or more crowdsourcing platforms.

A person skilled in the art would appreciate that one or more of the task design attributes may overlap with the task policy attributes. For example, the attribute “number of task instances” may be simultaneously included in the set of task policy attributes as well as in the set of task design attributes. In an embodiment, the grouping of the one or more task attributes into the task design attributes and the task policy attributes may be provided by the requestor. Alternatively, the application server 106 (or the policy simulator 107) may group the one or more task attributes into the task design attributes and the task policy attributes. In an embodiment, the application server 106 (or the policy simulator 107) may utilize the historical data to group the task attributes. For example, the policy simulator 107 may determine that values of the attributes “unit price” and “task price” are normally distributed across a time period (e.g., one month) such that coefficients of variation of the distributions associated with “unit price” and “task price” are 0.3 and 0.8, respectively. Thus, the attribute “unit price” may be grouped as a task design attribute (with values lying closer to mean, as coefficient of variation is less than 0.5), while the attribute “task price” may be grouped as a task policy attribute (with values lying further away from mean, as coefficient of variation is more than 0.5).

A person skilled in the art would appreciate that one or more of the task policy attributes may be functionally related to one or more of the task design attributes.

In an embodiment, a functional relationship between a task policy attribute and a corresponding task design attribute may be determined based on the historical data. In an embodiment, a functional relationship between a task policy attribute and a corresponding task design attribute may be inherent. For example, the task policy attribute “task price” may be directly proportional to the task design attribute “unit price per task”. For instance, the functional relationship between “unit price per task” (denoted as UP) and “task price” (denoted as TP) may be defined by the following equation:

TP=UP*BF (1)

where

BF corresponds to a Budget Factor.

In an embodiment, the Budget Factor (BF) may be determined based on the policy determined for the crowdsourcing of the set of incoming tasks, as is explained further. Thus, a person skilled in the art would appreciate that each task in the set of incoming tasks may be crowdsourced at the task price (TP), which in-turn may be equal to Budget Factor (BF) times the unit price per task (UP). As discussed above, the budget factor corresponds to the parameter, where the range of the parameters is received from the requestor.

For example, the requestor selects the task policy attribute “task price” for formulation of the policy. This selected task policy attribute (i.e., “task price”) is parameterized through the parameter “θ”. The requestor provides a range for the budget factor, say from 1.0 to 2.0. The parameter “θ” is utilized to choose a value for the budget factor from this range (i.e., from 1.0 to 2.0), thereby determining the value of the task policy attribute “task price”, which is budget factor times the unit price of the task (as per equation 1).

At step 304, the designated task design attribute and the range corresponding to the parameter are partitioned into a first and a second set of discrete values, respectively. In an embodiment, the processor 202 is configured to partition designated task design attribute and the range (e.g., budget range) into the first and the second set of discrete values, respectively. As discussed above, the requestor designates a task design attribute (e.g., unit price per task) as a designated task design attribute utilizable for formulation of the policy, in conjunction with the parameter (i.e., that controls the selected task policy attribute, e.g., task price per task).

Partitioning of the Range Associated with the Designated Task Design Attribute

As discussed above, the designated task design attribute is partitioned into the first set of discrete values within a first range. In an embodiment, the first range may be determined heuristically. For example, the first range corresponding to the task design attribute “unit price per task” may be determined based on the historical data. For instance, the minimum and the maximum remuneration paid to workers for performing tasks in the past (say, over the past one month) may be used to determine the first range of the attribute “unit price per task”. For example, if the minimum remuneration is 1.0 USD per task and the maximum remuneration is 2.0 USD per task, then the value of the task attribute “unit price per task” may be determined using a statistic such as, but not limited to, 1-standard deviation (1-SD), 2-SD, and so on, from the mean value of remuneration (i.e., 0.5 USD, in this case). In another embodiment, the first range corresponding to the task design attribute may be provided by the requestor along with the set of incoming tasks.

In an embodiment, the processor 202 may partition the first range corresponding to the task design attribute into r equal discrete sets. For example, the first range corresponding to the task design attribute “unit price per task” is 0.0 to 1.0 USD. The processor 202 may partition this first range into 10 equal discrete sets (i.e., r=10 in this case) of 10 cents (0.1 USD) each.

Partitioning of the Range Associated with the Selected Task Policy Attribute (Controlled Through Parameter)

As discussed above, the range corresponding to parameter is partitioned into the second set of discrete values. In an embodiment, the range corresponding to the parameter is a set of acceptable values for the budget factor when the task policy attribute under consideration is “task price”. In an embodiment, the processor 202 may partition this range (say, from bₘᵢₙ to bₘₐₓ) into m discrete actions within an action set A denoted by:

A={b(1),b(2), . . . ,b(m)};bmin≦b(1)<b(2)< . . . <b(m)≦bmax, and |A|=m (2)

Each discrete action in the action set A (as represented above in equation 2) corresponds to a discrete choice that is to be made from a policy space (for the task policy attribute under consideration) defined by the range (i.e., from bₘᵢₙ to bₘₐₓ). For example, if the range corresponding to the parameter, as received from the requestor, is from 1.0 to 2.0, (i.e., bₘᵢₙ=1.0 and bₘₐₓ=2.0), the action set A may be represented as:

A={b(1)=1.0, b(2)=1.25, b(3)=1.5, b(4)=1.75, b(5)=2.0}, where |A|=5 (3)

As is evident from equation 3 above, the action set A in the example scenario includes 5 discrete choices each lying between a policy space from 1.0 to 2.0.

Thereafter, in an embodiment, the processor 202 may generate a feature vector and a policy vector based on the partitioning, as discussed above. In an embodiment, the dimensions of the feature vector (φ) and the policy vector (θ) are both equal to r times m. In the above examples, r=10 and m=5, and hence the dimensions of the feature vector (φ) and the policy vector (θ) are equal to 50. The generation of the feature vector and the policy vector are explained next with the help of examples.

### Feature Vector (φ)

In an embodiment, for each discrete choice i (denoted by action b(i)) from the action set A, the processor 202 generates a feature vector (φₖ), where k corresponds to a discrete value from the first range that includes discrete set of values of the task design attribute. Thus, if the value of the task design attribute lies in the interval bₘᵢₙ*(k−1) to bₘᵢₙ*k (i.e., bₘᵢₙ*(k−1)≦value<bₘᵢₙ*k), the value is said to lie in the k^{th} interval.

In an embodiment, for the discrete action choice b(i), the processor 202 generates the feature vector (φₖ) as a standard basis vector of dimension r times m, whose ((k−1)*m+i)^{th} element is 1, all the others being 0. Thus, in case of the aforementioned example, if the discrete action set A is defined by equation 3, the feature vector (φₖᵢ) is a standard basis vector of dimension 50 (as r=10 and m=5) with the ((3−1)*5+i)^{th} element as 1 (as k=3) and the remaining elements as 0. Hence, for the discrete choice b(1), i.e., i=1, the feature vector PO is a standard basis vector with the ((3−1)*5+1)th element as 1 and the other elements as 0. Similarly, for the discrete choice b(2), i.e., i=2, the feature vector (φₖ₂) is a standard basis vector with the ((3−1)*5+2)^{th} elements as 1 and the other elements as 0, and so on.

### Policy Vector (θ)

In an embodiment, the policy vector corresponds to a vector version of the task policy attribute under consideration with the same dimension as each feature vector, i.e., r times m. In an embodiment, the value of the task policy attribute under consideration, controlled through the policy vector, is optimized to formulate a policy for crowdsourcing the set of incoming tasks. In the above example, the policy vector (θ) is a tunable parameter, which in-turn is a vector of dimension 50, determined through a dot product of a vector of dimension ‘r’, say R ([A₁ A₂ A₃ . . . Aᵣ]) with a transpose of a vector of dimension ‘m’, say M ([B1 B2 B3 . . . Bₘ]). Thus, θ=R·M^{T}, where the vector R corresponds to the task design attribute and the vector M corresponds to the parameter received from the requestor.

A person skilled in the art would appreciate that the scope of the disclosure should not be limited to the generation of the feature vector and the policy vector, as described above. The feature vector and the policy vector may be generated in various other ways without departing from the scope of the disclosure.

At step 306, the first value is assigned to the policy vector. In an embodiment, the processor 202 is configured to assign the first value to the policy vector. In an embodiment, the first value (denoted by θ₀) may correspond to a default value, selected based on a heuristic. For example, the processor 202 may choose a minimum value or a mean value from the range received from the requestor, as the default value, i.e., the first value. For instance, if the range is from 1.0 to 2.0, the first value, i.e., θ₀, may be determined as 1.0 (minimum value) or 1.5 (mean value), as the case may be. In another embodiment, the processor 202 may determine the first value, i.e., θ₀, based on the historical data. Alternatively, the first value may be received from the requestor. A person skilled in the art would appreciate that any other heuristic may be used to select the default value without departing from the scope of the disclosure.

At step 308, a probability distribution for selecting discrete actions from the policy space corresponding to the task policy attribute is determined. In an embodiment, the processor 202 is configured to determine the probability distribution for selecting discrete actions from the action set A based on the feature vector corresponding to each discrete action. In an embodiment, the following equation represents the probability π(i) for selecting a decision action b(i) from the action set A:

$$π ( i ) = \frac{{e}^{{Φ}_{ki}^{T} \cdot ϑ}}{{\sum }_{j = 1}^{m} {e}^{{Φ}_{kj}^{T} \cdot ϑ}} \qquad ( 4 )$$

where

[.]^{T}: Transpose.

As is evident from equation 4, the probability of selection of each discrete action b(i) is dependent on the feature vector corresponding to that discrete action, i.e., φₖᵢ. In an embodiment, the probability distribution, represented by equation 4, is used for formulating the policy for crowdsourcing of the set of incoming tasks. To that end, in an embodiment, the processor 202 formulates an objective function f(θ) to be optimized based on the probability distribution and the historical data. In an embodiment, the processor 202 may utilize the policy simulator 107 to optimize the objective function f(θ).

Objective Function f(θ)

In an embodiment, the objective function f(θ) may correspond to one or more performance metrics determined based on a given value of the policy vector θ. In an embodiment, the processor 202 may utilize the policy simulator 107 to determine the one or more performance metrics based on the current value of the policy vector θ, as described further. In an embodiment, the one or more performance metrics may include, but are not limited to, a completion time, an accuracy, or a quality, associated with the set of incoming tasks. The following equation represents an example of the objective function f(θ):

ƒ(θ)=w₁*p₁(θ)+w₂*p₂(θ)+ . . . +wₙ*pₙ(θ) (5)

where

w₁, w₂, . . . wₙ represent weights, and

p₁(θ), p₂(θ), . . . pₙ(θ) represent performance metrics, such as completion time, accuracy, quality, and so on, which are in-turn dependent on the value of the policy vector.

A person skilled in the art would appreciate that the weights may be determined based on any heuristic or technique known in the art. In an embodiment, the processor 202 may utilize the policy simulator 107 to determine the weights based on the historical data. Alternatively, the requestor may provide the weights. For example, if a requestor is more concerned about completion time, a higher weight may be assigned corresponding to the performance metric completion time, and so on.

At step 310, a perturbation of the first value of the policy vector θ is generated. In an embodiment, the processor 202 is configured to generate the perturbation of the first value of the policy vector θ. In an embodiment, the perturbation may correspond to a simultaneous perturbation of the policy vector θ across each dimension of the policy vector θ. The following equation represents a perturbation vector (Δ) that may be used to generate the simultaneous perturbation of the policy vector θ:

Δ={Δ(1),Δ(2), . . . ,Δ(d)}^{T} (6)

where

{Δ(i)}; i=1 . . . d: d Bernoulli random variables that take values in the set {−1,1} with equal probability;

[.]^{T}: Transpose; and

d: Dimension of the policy vector θ.

In an embodiment, the perturbation of the first value of the policy vector θ is determined based on the following equation:

θ_{0(perturbed)}=θ₀+δΔ (7)

where

θ_{0(perturbed)}: the perturbation of the first value of the policy vector θ,

θ₀: the first value of the policy vector θ,

δ: a small value close to 0 (a delta difference), and

Δ: the perturbation vector (refer equation 6).

In an embodiment, the processor 202 is configured to perform a gradient update on the first value of the policy vector, i.e., θ₀, based on the perturbation of the first value, i.e., θ_{0(perturbed)}. To that end, in an embodiment, the processor 202 may utilize the policy simulator 107 to determine one or more first performance metrics based on the first value, i.e., θ₀. Further, in an embodiment, the processor 202 may determine one or more second performance metrics based on the perturbation of the first value, i.e., θ_{0(perturbed)}.

At step 312, an execution of a first policy, corresponding to the first value, and an execution of a second policy, corresponding to the perturbation of the first value, are simulated on the policy simulator 107. In an embodiment, the processor 202 is configured to simulate the execution of the first policy and the second policy on the policy simulator 107. As explained earlier, the policy simulator 107 may correspond to a statistical simulator that determines one or more performance metrics based on a given value of the policy vector for a given period of time. In an embodiment, the first policy may correspond to a default policy determined based on the first value of the policy vector, i.e., θ₀. Thus, if the first policy may correspond to the default value, e.g., 1.0 for the budget factor (i.e., the parameter). Similarly, if, for instance, the perturbation of the first value of the policy vector (i.e., θ_{0(perturbed)}) for the policy attribute “task price” is 1.15, this value (i.e., 1.15) is indicative of the second policy, parameterized by D. Thus, the second policy corresponds to assigning the value of 1.15 to the budget factor (i.e., the parameter).

In an embodiment, the policy simulator 107 may determine the one or more first performance metrics based on the historical data and the first policy (which is indicative of the first value of the policy vector, i.e., θ₀). Similarly, based on the historical data and the second policy (which is indicative of the perturbation of the first value, i.e., θ_{0(perturbed)}), the policy simulator 107 may determine the one or more second performance metrics. In an embodiment, the one or more performance metrics may include, but are not limited to, a task completion time, a task accuracy, and a task quality, associated with the crowdsourcing of the set of incoming tasks. The following table illustrates an example of the historical data, which may be used to determine the one or more performance metrics:

TABLE 2
Example of historical data

| Budget Range | Task Completion Time (minutes) |
|---|---|
| 1.00-1.10 | 13.43 |
| 1.10-1.20 | 11.02 |
| 1.20-1.30 | 6.44 |
| 1.30-1.40 | 4.53 |
| 1.40-1.50 | 3.48 |
| 1.50-1.60 | 2.82 |
| 1.60-1.70 | 2.36 |
| 1.70-1.80 | 2.03 |
| 1.80-1.90 | 1.78 |
| 1.90-2.00 | 1.59 |

The above table illustrates an example of the historical data collected over a period of time (say, a previous month) that includes a distribution of completion times (in minutes) of tasks crowdsourced on the crowdsourcing platform (e.g., the crowdsourcing platform 104a) versus the task price associated with such tasks. As is evident from Table 2, the distribution associated with task completion times may correspond to power law distributions. Based on the distribution determined for the task completion time, the policy simulator 107 may determine that the task completion time for tasks in the set of incoming tasks as 13.43 and 11.02 minutes for the first policy (corresponding to θ₀=1.00) and the second policy (corresponding to θ_{0(perturbed)}=1.15) respectively. Thus, in the above example, the values of the one or more first performance metrics and the one or more second performance metrics are 13.43 and 11.02 minutes (approximately), respectively.

A person skilled in the art would appreciate that the above example of historical data is for illustrative purposes only. Further, the scope of the disclosure should not be limited to the determination of the one or more performance metrics, as discussed above.

Further, based the one or more performance metrics, the processor 202 may determine the corresponding values for the objective function f(θ), parameterized by θ, using equation 5. The processor 202 determines the simulated objective functions f(θ₀) and f(θ_{0(perturbed)}) corresponding to the one or more first performance metrics and the one or more second performance metrics, respectively.

In an embodiment, the execution of the simulation to determine the one or more performance metrics (such as, the one or more first performance metrics and the one or more second performance metrics) using the policy simulator 107 has been explained further in FIG. 5.

At step 314, the first value of the policy vector is updated. In an embodiment, the processor 202 is configured to perform an update on the first value of the policy vector (i.e., θ₀). In an embodiment, the update corresponds to a gradient update performed on the policy vector (0) based on the one or more first performance metrics, the one or more second performance metrics, the first value, and the perturbation of the first value. In an embodiment, the processor 202 may perform the gradient update using Simultaneous Perturbation Stochastic Approximation (SPSA) technique based on the following equation:

$${ϑ}_{n + 1} ( i ) = {ϑ}_{n} ( i ) - a ( n ) \frac{f ( {ϑ}_{n} + {δΔ}_{n} ) - f ( {ϑ}_{n} )}{{δΔ}_{n} ( i )} \qquad ( 8 )$$

where

i: iteration counter,

θₙ₊₁(i): updated value of the parameter at the end of the iteration i,

θₙ(i): initial value of the parameter at the beginning of the iteration i,

f(θₙ): value of the objective function based on the initial value of parameter (θₙ)

ƒ(θₙ+δ Δₙ): value of the objective function based on the perturbed value of parameter (refer equation 7), and

a(n): step size corresponding to the gradient update, which satisfies the following conditions:

Σₙa(n)=∞ and Σₙa²(n)<∞ (9)

Referring to the equation 8 above, as the current iteration is the first iteration, the value of i is 0 (assuming the first iteration is denoted as iteration 0). Further, θₙ corresponds to the first value of the policy vector (θ₀). As is evident, the functions f(θₙ) and ƒ(θₙ+δ Δₙ) correspond to the simulated objective functions f(θ₀) and f(θ_{0(perturbed)}) respectively. The updated value θₙ₊₁ is referred to as the second value of the policy vector (i.e., θ₁).

A person skilled in the art would appreciate that the gradient update may be performed using any other technique known in the art without departing from the scope of the disclosure.

At step 316, a termination condition is checked. In an embodiment, the processor 202 is configured to check whether the termination condition has been reached. For example, the following condition may be used as the termination condition:

∥θₙ₊₁(i)−θₙ(i)∥≦ε (10)

where

ε: a predetermined threshold; and

∥.∥: modulus function.

A person skilled in the art would appreciate that the above termination condition is an example that is for illustrative purposes only. The scope of the disclosure should not be limited to this example. Any suitable condition may be used as the termination condition. For example, if the difference between the objective functions at two consecutive iterations is below a predetermined threshold, the termination condition may have reached and the algorithm may have converged. Another example of the termination condition is the case in which a target value of the objective function has been reached at a particular iteration. Alternatively, the terminal condition may correspond to a number of predetermined number of iterations or a predetermined processing time associated with performing the update. In an embodiment, the terminal condition may be provided by the requestor.

If at step 316, the termination condition evaluates to false, the processor 202 may repeat steps 308 to 316, otherwise, the updated value (referred as θ*) of the policy vector, as obtained in the last iteration is indicative of the policy for crowdsourcing of the set of incoming tasks. In an embodiment, the final value of the policy vector (θ*), i.e., the updated value of the policy vector obtained at the final iteration is usable to select a value for the task policy attribute under consideration. This selected value of the task policy attribute corresponds to the policy for crowdsourcing the set of incoming tasks.

At step 318, an expected value of the parameter, controlling the task policy attribute under consideration, is determined. In an embodiment, the processor 202 is configured to determine the expected value of the parameter (e.g., budget parameterized by θ) based on the final updated value of the policy vector (i.e., θ*) using the following equation:

Eₚₐᵣ(ƒ or θ*)=Σᵢ₌₁^{m}π(i)*b(i) (11)

where

Eₚₐᵣ(for θ*): expected value of the parameter based on the final value of the policy vector (θ*),

π(i): probability of selecting action b(i) (refer equation 4), and

b(i): a discrete action in the action set A (refer equation 2).

As is evident from equation 11, the expected value of the parameter (e.g., budget) is determined based on the probability distribution represented by π (i), which is determined using equation 4 based on the final value of the policy vector (θ*). The following table illustrates the determination of expected value of the parameter considering the example scenario of the action set “A” of equation 3:

TABLE 3
Example of determination of the expected value of the parameter

| b(i) | π(i) | π(i) * b(i) |
|---|---|---|
| 1.0 | 0.05 | 0.05 |
| 1.25 | 0.25 | 0.3125 |
| 1.5 | 0.45 | 0.675 |
| 1.75 | 0.20 | 0.35 |
| 2.0 | 0.05 | 0.1 |

In the above table, the first column represents the various discrete actions (represented by b(i)) from the action set A (refer example action set in equation 3). The second column of the above table illustrates example values of the probability (represented by π (i)) of selecting the corresponding discrete action, i.e., b(i), from the action set A. In an embodiment, this value of probability, i.e., π(i), may be determined using equation 4. As is evident from the table, the third column presents the product of the values in the first and the second column. Thus, in the above example, the expected value of the parameter is 1.4875 (i.e., 0.05+0.3125+0.675+0.35+0.1). Hence, the tasks in the set of incoming tasks may be crowdsourced using the budget value of 1.4875, which in this case is representative of the policy so formulated. Thus, in this case, the set of incoming tasks may be crowdsourced at the “task price” of 1.4875 USD, if the “unit price” is considered as 1.0 USD.

A person skilled in the art would appreciate that the scope of the disclosure should not be limited to the task policy attributes being indicative of the policy for crowdsourcing of the tasks in the set of incoming tasks. In an embodiment, the task design attributes could also be indicative of the policy for crowdsourcing of the tasks in the set of incoming tasks. In such a scenario, such task design attributes may be included in the list of task policy attributes and tuned accordingly by utilizing the policy vector.

FIG. 4 is a flowchart 400 that illustrates a method for formulating a pricing policy for crowdsourcing of the set of incoming tasks, in accordance with at least one embodiment. The flowchart 400 is described in conjunction with FIG. 1, FIG. 2, and FIG. 3.

At step 402, the set of incoming tasks and a range corresponding to a cost incurable by a requestor on each task is received from the requestor. In an embodiment, the processor 202 is configured to receive the set of incoming tasks and the range corresponding to the cost incurable (the selected task policy attribute) by the requestor on each task. In an embodiment, the cost incurable by the requestor corresponds to a budgeted cost allocated by the requestor, which the requestor is willing to incur on each task. Thus, the task policy attribute under consideration in this case is the “task cost”, also referred interchangeably hereinafter as “task price”. A person skilled in the art would appreciate that each task may have one or more associated task attributes that include task design attributes and task policy attributes. In this case, the task policy attribute includes the attribute “task cost” (or task price). The task design attributes may include task attributes such as, but not limited to, a posting time of tasks, an expiry time of the set of incoming tasks, a task type associated with each task, a number of task instances in the set of incoming tasks, and a unit price associated with each task. In an embodiment, one of the task design attributes may be designated as an attribute required for formulation of the pricing policy.

At step 404, the designated task design attribute and the range corresponding to the parameterized task policy attribute under consideration (i.e., task cost), are partitioned into the first and the second set of discrete values, respectively. In an embodiment, the processor 202 is configured to partition the designated task design attribute into the first set of discrete values, in a manner similar to that described in step 304. Further, the processor 202 is configured to partition the parameterized task policy attribute under consideration (i.e., the task cost) into the second set of discrete values within the range of cost received from the requestor, in a manner similar to that described in step 304.

Thereafter, as explained in step 304, the processor 202 generates the feature vector (φ) based on the designated task design attribute partitioned in the first set of discrete values. Further, the processor 202 generates the policy vector (θ) based on task policy attribute under consideration partitioned in the second set of discrete values, as explained in step 304.

At step 406, a first value (e.g., a default value) is assigned to the policy vector that controls the task policy attribute under consideration (e.g., task cost). In an embodiment, the processor 202 may assign the first value (e.g., the default value, θ₀) to the policy vector (θ), in a manner similar to that explained in step 306.

At step 408, a probability distribution for selecting a discrete value of task cost from the budgeted cost range, received from the requestor, is determined. In an embodiment, the processor 202 is configured to determine the probability distribution, in a manner similar to that described in step 308. For example, the processor 202 may use equation 4 to determine the probability distribution. Further, in an embodiment, the processor 202 may formulate an objective function based on one or more performance metrics (e.g., task completion time). In an embodiment, the processor 202 may utilize the policy simulator 107 to determine one or more performance metrics based on the current value of the policy vector (θ). The following equation is an example of the objective function that may be formulated by the processor 202:

ƒ(θ)=w₁*CT(θ)+w₂*(EB(θ)−1) (12)

where

w₁, w₂: weights,

CT(θ): average completion time of the tasks for the current value of task cost, represented by policy vector θ, and

EB(θ): spending ratio.

In the example objective function of equation 12, CT(θ) refers to an average completion time of the tasks in the set of incoming tasks, which is a performance metric that may be determined based on the current value of the policy vector θ. Further, the term EB(θ) corresponds to a spending ratio that is a ratio of total pricing of the set of incoming tasks (denoted by Tot_{Pr}) to total valuation of the set of incoming tasks (denoted by Tot_{Val}). Thus, the term EB(θ)−1 is indicative of the excess spending on the set of incoming tasks over the true valuation of these tasks. A person skilled in the art would appreciate that the role played by the term EB(θ)−1 is similar to that played by the term Budget Factor (BF), as provided in equation 1. The following equations represent the relationships defining the terms EB(θ), Tot_{Pr}, and Tot_{Val}:

$$\begin{matrix}EB ( ϑ ) = \frac{{Tot}_{Pr} ( ϑ )}{{Tot}_{Val} ( ϑ )} & ( 13 ) \\ {Tot}_{Pr} ( ϑ ) = {\sum }_{i = 1}^{n} {nh}_{i} * ϑ ( {T}_{i} ) * {UP}_{i} & ( 14 ) \\ {Tot}_{Val} ( ϑ ) = {\sum }_{i = 1}^{n} {nh}_{i} * 1 * {UP}_{i} & ( 15 )\end{matrix}$$

where

n: number of tasks in the set of incoming tasks,

nhᵢ: number of task instances in a task Tᵢ,

UPᵢ: unit price associated with the task Tᵢ, and

θ(Tᵢ): task cost for the task Ti, where θ is the current value of the policy vector.

At step 310, a perturbation of the first value of the policy vector is generated. In an embodiment, the processor 202 is configured to generate the perturbation of the first value of the policy vector, i.e., θ_{0(perturbed)}. Step 310 has already been explained in conjunction with FIG. 3.

At step 312, an execution of a first policy, corresponding to the first value, and an execution of a second policy, corresponding to the perturbation of the first value, are simulated on the policy simulator 107. In an embodiment, the processor 202 is configured to simulate the execution of the first policy and the second policy on the policy simulator 107. Step 312 has already been explained in conjunction with FIG. 3.

At step 314, the first value of the policy vector is updated. In an embodiment, the processor 202 is configured to perform an update on the first value of the policy vector (i.e., θ₀). In an embodiment, the update corresponds to a gradient update performed on the policy vector (θ) based on the one or more first performance metrics, the one or more second performance metrics, the first value, and the perturbation of the first value. In an embodiment, the gradient update may be performed based on SPSA algorithm, represented in equation 8. Step 314 has already been explained in conjunction with FIG. 3.

At step 316, a termination condition is checked. In an embodiment, the processor 202 is configured to check whether the termination condition has been reached. Step 316 has already been explained in conjunction with FIG. 3. If at step 316 the terminal condition evaluates to false, steps 408 through 316 are iterated, otherwise, step 410 is performed.

At step 410, the expected value of the parameterized task policy attribute (i.e., task cost), indicative of the policy for crowdsourcing of the incoming tasks, is determined based on the final updated value (θ*) of the policy vector. Step 410 is similar to step 318 explained in conjunction with FIG. 3. For example, the processor 202 may determine an expected value of the parameterized “task cost” based on the probability distribution, which is determined using equation 4, based on the final value of the policy vector (θ*). In an embodiment, the processor 202 may utilize equation 11 to determine the expected value of “task cost”.

Thus, the expected value of parameterized task cost, so determined at step 410 may correspond to a cost value that leads to a minimization of the time taken to complete the tasks in the set of incoming tasks, while simultaneously keeping a tap on the budget, i.e., the excess spending over the unit valuation of tasks, given by the term EB(θ)−1.

FIG. 5 is a block diagram 500 that illustrates an example of the policy simulator 107 used for formulating the policy for crowdsourcing of the set of incoming tasks, in accordance with at least one embodiment.

As shown in FIG. 5, the policy simulator 107 may use one or more processes (or mathematical models) for simulating the execution of a policy for crowdsourcing of the tasks. In an embodiment, the policy simulator 107 may utilize a task grouping process 504, a requestor process 508, a worker arrival process 510, and a task utility process 512. In an embodiment, each of the processes (i.e., 504, 508, 510, and 512) may correspond to a mathematical model generated based on the historical data. For example, the requestor process 508 may model a behavior of the one or more requestors, while the worker arrival process 510 may model a behavior of the one or more workers.

A person skilled in the art would appreciate that the requestor process 508 may model the behavior of a single requestor or a group of requestors associated with a crowdsourcing platform. In an embodiment, tasks received by the crowdsourcing platform from other requestors associated with the crowdsourcing platform may be modeled based on a mathematical model (denoted by 502).

In an embodiment, the policy simulator 107 may comprise a crowdsourcing platform model 516, which may in-turn comprise the processes 502, 504, 506, 510, and 512. In an embodiment, the crowdsourcing platform model 516 may determine a performance metric associated with processing of the set of crowdsourcing tasks on a crowdsourcing platform (e.g., 104a). As illustrated in FIG. 5, the crowdsourcing platform model 516 computes the performance metric f(θ), denoted by 518. In an embodiment, the policy simulator 107 may utilize the crowdsourcing platform model 516 to simulate an execution of a crowdsourcing policy and determine the resultant performance metric, as discussed later.

A person skilled in the art would appreciate that the scope of the disclosure is not limited to the one or more processes (i.e., 502, 504, 508, 510, and 512) being realized as mathematical models. In an embodiment, the one or more processes (i.e., 502, 504, 508, 510, and 512) may be integrated with the crowdsourcing platform (e.g., 104a) such that inputs/outputs to/from the one or more processes (i.e., 502, 504, 508, 510, and 512) may correspond to real-time data obtained based on the actual crowdsourcing of the set of tasks or a part therefrom on the crowdsourcing platform (e.g., 104a). For example, the worker arrival process 510 may correspond to the actual workers, and similarly the requestor process 508 may correspond to the actual requestors. In such a scenario, the inputs/outputs to/from such processes may correspond to real-time data.

In an embodiment, the requestor process 508 may model a behavior of one or more requestors. To that end, the requestor process 508 may generate a traffic of tasks (as model through a task arrival process 520) including the set of incoming tasks. In an embodiment, the arrival of the traffic of tasks may be modeled using a Poisson Process with rate λ_{Task} by the task arrival process 520. In an embodiment, one or more task design attributes associated with the set of incoming tasks may be provided by the requestor process 508. For example, posting time, expiry time, number of task instances, task type, and so on.

In an embodiment, the policy simulator 107 may group the set of incoming tasks within the traffic of tasks, as received from the requestor process 508. In an embodiment, the policy simulator 107 may utilize the task grouping process 504 to group the set of incoming tasks into task groups denoted within the pending tasks repository 506. An arrow from the task grouping process 504 to the pending tasks repository 506 represents the grouped tasks being sent into the pending tasks repository 506. For example, the pending tasks repository 506 includes a task group 1 (500 tasks@0.5 USD/task), a task group 2 (300 tasks@0.7 USD/task), and a task group 3 (100 tasks@0.2 USD/task).

In an embodiment, the worker arrival process 510 models the behavior of one or more workers associated with the crowdsourcing platform (e.g., 104a). To that end, the worker arrival process 510 may generate an event corresponding to a worker's arrival on the crowdsourcing platform at a rate of λ_{Worker}. In an embodiment, the arrival of workers may be modeled using a non-homogenous Poisson Process. Further, in an embodiment, the worker arrival process 510 may generate a utility function for each arriving worker. In an embodiment, the utility function corresponding to each arriving worker may be fed into the task utility process 512.

In an embodiment, the task utility process 512 may determine a task selection criteria for each worker based on the utility function associated with that worker. In an embodiment, the task selection criteria corresponds to a Logit preference model represented by the following equation:

$$p ( k ) = \frac{{e}^{{ζ}_{k}^{t} \cdot β}}{{\sum }_{i = 1}^{n} {e}^{{ζ}_{i}^{t} \cdot β}} \qquad ( 16 )$$

where

n: number of pending tasks,

p(k): probability of picking k^{th} task,

ζₖ: utility function (in vector form) for the worker,

β: a weight vector corresponding to each variable in the utility function, and

t: the current time, which is associated with the simulation of the preference model.

As is evident from the above equation, p(k) that denotes the worker's probability of picking a task k from the set of n pending tasks is based on the utility function of the worker for the task k (denoted by ζₖ). In an embodiment, one or more variables within the utility function may correspond to one or more task design parameters associated with the task in consideration. An example representation of the utility function corresponding to a task k is:

ζₖ=(nrₖ,t−pTₖ,eTₖ−t,upₖ) (17)

where

nrₖ: number of remaining task instances of the task k,

pTₖ: posting time associated with the task k,

eTₖ: expiry time associated with the task k, and

upₖ: unit price associated with the task k.

In an embodiment, the weight vector corresponding to the utility function may be determined based on the historical data. Further, the values within the utility function, represented in the vector form, may be normalized such that the mean of the values lies within the interval of 0.5 to 1. Based on the utility function, so determined for each worker for each task within the pending tasks repository 506, one or more tasks may be selected for the particular worker.

Thereafter, based on the historical data, the policy simulator 107 may simulate an execution of the selected tasks on the crowdsourcing platform for a period of time (T). In an embodiment, the policy simulator 107 may utilize the crowdsourcing platform model 516 to simulate the execution of the selected tasks. In an embodiment, based on the simulation of the selected tasks (at a given policy), the crowdsourcing platform model 516 determines the one or more performance metrics, represented as f(θ) (denoted by 518). In an embodiment, the execution of the selected tasks may correspond to the execution of a policy for crowdsourcing the tasks. In an embodiment, the policy (represented in a vector form) may correspond to a value of the parameterized task policy attribute associated with each task (denoted by the task policy formulation 522). In an embodiment, an initial policy (corresponding to the first value of the parameter) may be provided by the requestor process 508. Thereafter, the initial policy may be tuned to formulate a second policy, as determined at step 318. In an embodiment, the second policy may be provided to the requestor process 508 as a task design/policy feedback.

To simulate the execution of the selected tasks, in an embodiment, one or more performance metrics (e.g., task completion time, task accuracy, task quality, etc.) associated with the completion of the selected tasks may be determined, as described above. Based on the value one or more performance metrics, the policy simulator 107 determines the value of an objective function (e.g., f(θ)). In an embodiment, the policy simulator 107 utilizes SPSA algorithm (depicted by 514) to perform a gradient update on the initial value of the policy vector. As depicted in 514, a simultaneous perturbation of the initial value of the policy vector may be generated. Thereafter, the policy simulator 107 may simulate an execution of a second policy, corresponding to the perturbation of the initial value of the policy vector. Thus, a second version of the objective function (for the perturbation of the initial value) may be obtained. Further, the policy simulator 107 may perform a gradient update on the policy vector, as depicted in 514. If the updated value of the policy vector satisfies a termination condition (e.g., as described in step 316), the updated value is used as a basis for the policy of crowdsourcing the set of incoming tasks. Example, an expected value of the task policy attribute may be determined based on the final updated value of the policy vector. However, if the updated value does not satisfy the termination condition, another iteration of the gradient update is performed.

A person skilled in the art would appreciate that the policy simulator 107 (through the crowdsourcing platform model 516) may provide the one or more performance metrics, so determined, as a feedback indicative of the task design/policy chosen by the requestor process 508. In addition, the policy simulator 107 (through the crowdsourcing platform model 516) may also provide results associated with the tasks, so completed, to the requestor process 508. Further, the policy simulator 107 may recommend the policy formulated based on the final gradient update of the policy vector to the requestor process 508. The use of the policy simulator 107 for simulating the execution of one or more policies (such as the first and the second policy) has been explained further in step 312.

A person skilled in the art would appreciate that the policy simulator 107 may provide the one or more performance metrics, so determined, as a feedback indicative of the task design/policy chosen by the requestor process 508. In addition, the policy simulator 107 may also provide results associated with the tasks, so completed, to the requestor process 508. Further, the policy simulator 107 may recommend the policy formulated based on the final gradient update of the policy vector to the requestor process 508. The use of the policy simulator 107 for simulating the execution of one or more policies (such as the first and the second policy) has been explained further in step 312.

In an embodiment, the requestor process 508 may formulate a policy for crowdsourcing of set of outgoing tasks (i.e., incoming tasks for the crowdsourcing platform, e.g., 104a or the policy simulator 107) based on the feedback on task design/policy received from the policy simulator 107. The formulation of the policy for crowdsourcing of the set of outgoing tasks (i.e., incoming tasks for the crowdsourcing platform, e.g., 104a or the policy simulator 107) has been explained further in conjunction with FIG. 3.

The disclosed embodiments encompass numerous advantages. The use of the policy simulator 107 enables a requestor to formulate a policy for crowdsourcing of the requestor's traffic of tasks (including the set of incoming tasks) in a manner that may yield a desirable output (measured in terms of a performance metric, e.g., task completion time, etc.) from the crowdsourcing platform. Further, the feedback-based system disclosed herein may enable the requestor to tune one or more task design attributes associated with the tasks for achieving a desirable performance metric. The present disclosure provides for an online system as the historical data used by the policy simulator 107 is regularly updated to reflect the current dynamics of the crowdsourcing platform.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for formulating a policy for crowdsourcing of tasks have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for formulating a policy for crowdsourcing tasks, the method comprising:
receiving, by one or more processors, a set of incoming tasks and a range associated with a task attribute corresponding to each task in the set of incoming tasks;
simulating, by the one or more processors, an execution of a first policy over a period of time to determine one or more first performance metrics, associated with the execution of the first policy, wherein the first policy is based on a first value selected from the range; and
updating, by the one or more processors, the first value to generate a second value based on the one or more first performance metrics, wherein the second value is deterministic of the policy for crowdsourcing of the set of incoming tasks over the period of time.

2. The method of claim 1 further comprising partitioning, by the one or more processors, the task attribute associated with each task into a set of discrete values.

3. The method of claim 2 further comprising determining, by the one or more processors, a probability distribution of choosing values from the set of discrete values based at least on the task attribute associated with each task in the set of incoming tasks.

4. The method of claim 2 further comprising determining, by the one or more processors, the first value from the set of discrete values based on a historical data associated with crowdsourcing of tasks on a crowdsourcing platform.

5. The method of claim 1 further comprising generating, by the one or more processors, a perturbation of the first value.

6. The method of claim 5 further comprising simulating, by the one or more processors, an execution of a second policy over the period of time to determine one or more second performance metrics, associated with the second policy, wherein the second policy is based on the perturbation of the first value.

7. The method of claim 6, wherein the updating of the first value corresponds to performing, by the one or more processors, a gradient update on the first value based on the one or more first performance metrics, the one or more second performance metrics, the first value, and the perturbation of the first value.

8. The method of claim 1, wherein the task attribute corresponds to a task policy attribute selected by a requestor from one or more task policy attributes, associated with each task, for formulating the policy.

9. The method of claim 1, wherein the one or more first performance metrics comprise at least one of a completion time associated with the set of incoming tasks, an accuracy associated with the set of incoming tasks, or a quality associated with the set of incoming tasks.

10. The method of claim 1, wherein the task attribute corresponding to each task in the set of incoming tasks comprises at least one of a posting time of the set of incoming tasks, an expiry time of the set of incoming tasks, a number of instances of each task within the set of incoming tasks, a task type associated with each task, a unit price associated with each task, a price associated with tasks from the set of incoming tasks, one or more crowdsourcing platforms for crowdsourcing of the tasks, a task schedule associated with crowdsourcing of the tasks, a re-posting of the task on a crowdsourcing platform, or a task switching between the one or more crowdsourcing platforms.

11. The method of claim 1, wherein the one or more first performance metrics are determined based on a distribution of at least of a posting of the set of incoming tasks on a crowdsourcing platform, an arrival of workers on the crowdsourcing platform, or a task selection from the set of incoming tasks by the workers.

12. A method for formulating a pricing policy for crowdsourcing tasks, the method comprising:
receiving, by one or more processors, a set of incoming tasks and a range of a cost incurable by a requestor on each task in the set of incoming tasks;
simulating, by the one or more processors, an execution of a first policy over a period of time to determine a first completion time, associated with the execution of the first policy, wherein the first policy is based on a first value of the cost selected from the range, wherein the first completion time corresponds to a time consumable by one or more crowdworkers for completing the set of incoming tasks when crowdsourced at the first policy, wherein the simulation of the execution of the first policy further comprises simulating a behavior of the one or more crowdworkers; and
updating, by the one or more processors, the first value to generate a second value of the cost based on the first completion time, wherein the second value is deterministic of the pricing policy for crowdsourcing of the set of incoming tasks over the period of time.

13. The method of claim 12 further comprising simulating, by the one or more processors, an execution of a second policy over the period of time to determine a second completion time associated with the second policy, wherein the second policy is based on the second value of the cost, wherein the second completion time corresponds to a time consumable by the one or more crowdworkers for completing the set of incoming tasks when crowdsourced at the second policy.

14. The method of claim 13, wherein the updating of the first value corresponds to performing, by the one or more processors, a gradient update on the first value based on the first completion time, the second completion time, the first value, and the second value.

15. The method of claim 12, wherein the second value corresponds to a perturbation of the first value.

16. A system for formulating a policy for crowdsourcing tasks, the system comprising:
one or more processors configured to:
receive a set of incoming tasks and a range associated with a task attribute corresponding to each task in the set of incoming tasks;
simulate an execution of a first policy over a period of time to determine one or more first performance metrics, associated with the execution of the first policy, wherein the first policy is based on a first value selected from the range; and
update the first value to generate a second value based on the one or more first performance metrics, wherein the second value is deterministic of the policy for crowdsourcing of the set of incoming tasks over the period of time.

17. The system of claim 16, wherein the one or more processors are further configured to simulate an execution of a second policy over the period of time to determine one or more second performance metrics, associated with the second policy, wherein the second policy is based on the perturbation of the first value.

18. The system of claim 17, wherein to update the first value, the one or more processors are further configured to perform a gradient update on the first value based on the one or more first performance metrics, the one or more second performance metrics, the first value, and the perturbation of the first value.

19. The system of claim 16, wherein the one or more first performance metrics comprise at least one of a completion time associated with the set of incoming tasks, an accuracy associated with the set of incoming tasks, or a quality associated with the set of incoming tasks.

20. A computer program product for use with a computing device, the computer program product comprising a non-transitory computer readable medium, the non-transitory computer readable medium stores a computer program code for formulating a policy for crowdsourcing tasks, the computer program code is executable by one or more processors in the computing device to:
receive a set of incoming tasks and a range associated with a task attribute corresponding to each task in the set of incoming tasks;
simulate an execution of a first policy over a period of time to determine one or more first performance metrics, associated with the execution of the first policy, wherein the first policy is based on a first value selected from the range; and
update the first value to generate a second value based on the one or more first performance metrics, wherein the second value is deterministic of the policy for crowdsourcing of the set of incoming tasks over the period of time.
